(19) United States
(12) Patent Application Publication
(10) Pub. No.: US 2020/0397162 A1
(43) Pub. Date: Dec. 24, 2020

(54) DECORATIVE VASE INSERT ASSEMBLY

(71) Applicant: FLORISTS' TRANSWORLD DELIVERY, INC., Downers Grove, IL (US)

(72) Inventor: Andrea ANCEL, Chicago, IL (US)

(21) Appl. No.: 16/447,905

(22) Filed: Jun. 20, 2019

(51) Int. Cl. A47G 7/06; G09F 7/18

(52) U.S. Cl. CPC A47G 7/06; G09F 7/18

(57) ABSTRACT

An example apparatus comprises a vase insert for insertion into a vase, the vase insert having receptacles extending into the vase and a decorative frame. The decorative frame has a decorative shape portion and prongs coupled to the decorative shape portion, the prongs for insertion into the receptacles of the vase insert.

### BACKGROUND

Flowers are frequently given to friends or loved ones on various special occasions. Often, the flowers are placed or delivered in vases. The vases may then be placed on a flat surface for displaying the flowers.

### BRIEF DESCRIPTION OF THE DRAWINGS

For a more complete understanding of various examples, reference is now made to the following descriptions taken in connection with the accompanying drawings in which:

FIG. 1 illustrates a perspective view of an example vase arrangement;

FIGS. 2-4 illustrate an example method for assembling the example vase arrangement of FIG. 1;

FIG. 5 illustrates a perspective view of another example vase arrangement;

FIG. 6 illustrates a perspective view of another example vase arrangement;

FIG. 7 illustrates a perspective view of another example vase arrangement;

FIG. 8 illustrates a perspective view of another example vase arrangement; and

FIG. 9 illustrates the example vase arrangement of FIG. 8 in assembled form.

### DETAILED DESCRIPTION

Various examples describe example vase arrangements which allow for a vase to frame flowers placed in the vase with a decorative shape. In various examples, a vase is provided with receptacles which extend into the vase. The receptacles may be formed as part of the vase or may be formed on a vase insert that may be placed into the vase. The receptacles are provided to receive prongs of a decorative frame therein. The prongs are coupled to a decorative shape portion of the decorative frame. When flowers are added to the vase, the flowers are framed by the decorative shape portion of the decorative frame.

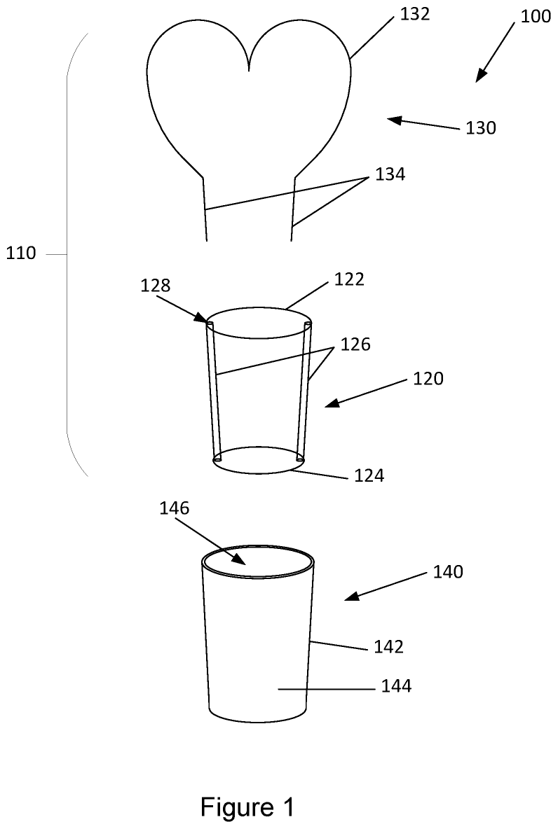

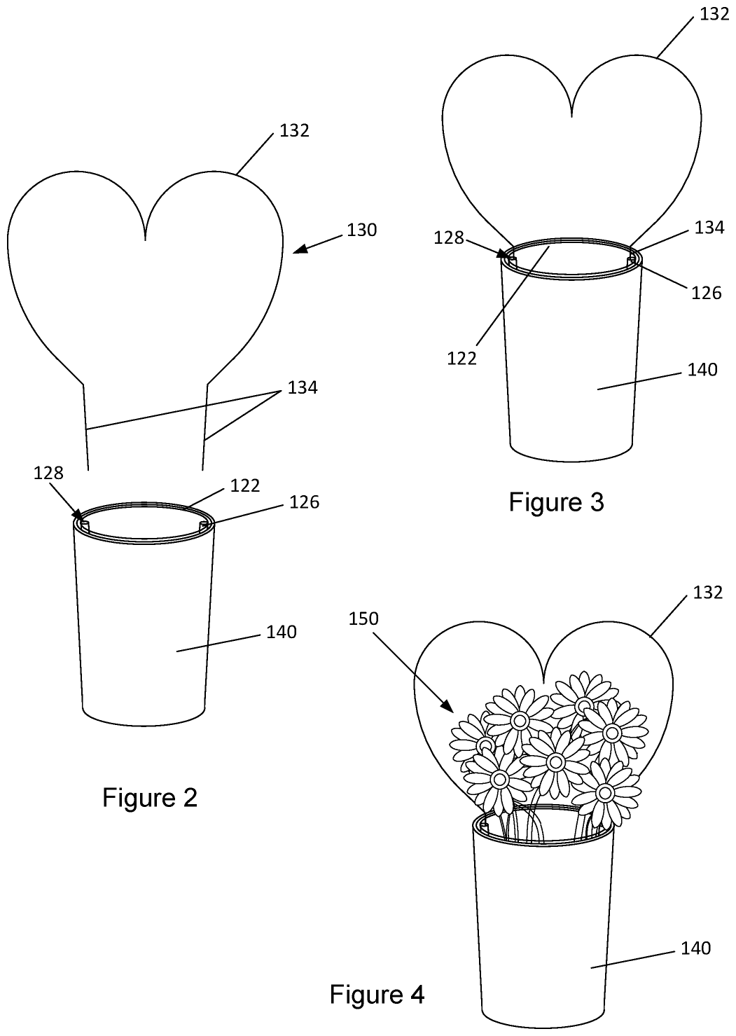

Referring now to FIG. 1, a perspective view of an example vase arrangement is illustrated. The example vase arrangement 100 of FIG. 1 may be formed in any desired size to accommodate a desired number and size of flowers, for example. The example vase arrangement 100 may be assembled, as described below with reference to FIGS. 2-4, using the various components of the example vase arrangement 100.

As illustrated in FIG. 1, the example vase arrangement 100 includes a decorative assembly 110 which includes a vase insert 120 and a decorative frame 130. The vase insert 120 is sized to fit into a vase 140 of the example vase arrangement 100. In one example, the vase insert 120 is sized and shaped to substantially conform to the inside of the vase 140.

The vase insert 120 of the example vase arrangement 100 is formed of a wire-frame structure. In this regard, the vase insert 120 includes a wire-frame body which includes an upper circumferential portion 122 and a lower circumferential portion 124. The lower circumferential portion 124 is sized and shaped to fit at the bottom inside surface of the vase 140, and the upper circumferential portion is sized and positioned to fit within the vase 140. The upper circumferential portion 122 and the lower circumferential portion 124 are connected and separated by at least two receptacles 126. The receptacles 126 are positioned to extend into the vase 140 from the upper circumferential portion 122 to the lower circumferential portion 124. The receptacles 126 are formed to form a hollow, straw-like shaft 128.

The decorative frame 130 of the example vase arrangement 100 of FIG. 1 includes a decorative shape portion 132 and prongs 134 coupled to the decorative shape portion 132. In various examples, the decorative shape portion 132 may be formed in any of a variety of desired shapes. For example, the example vase arrangement 100 of FIG. 1 is provided with a heart-shaped decorative shape portion 132 that may be appropriate and desirable for St. Valentine's Day, for example,

The prongs 134 are positioned and sized to fit into the hollow, straw-like shaft 128 of the receptacles 126 of the vase insert 120. As described below with reference to FIGS. 2-4, when the prongs 134 are inserted into the receptacles 126, the decorative shape portion 132 is positioned to frame flowers that may be placed in the vase 140. In one example, the receptacles 126 are formed of a hollow wire for receiving prongs therein. In various examples, such as the example illustrated in FIG. 1, the receptacles 126 include two receptacles formed on opposing regions of vase insert 120.

The vase insert 120, including the upper circumferential portion 122, the lower circumferential portion 124 and the receptacles 126 may be formed of any of a variety of materials. In one example, the vase insert 120 is formed of a metal. In other examples, the vase insert 120 is formed of a plastic. Of course, any of a number of other materials may be used. Similarly, the decorative frame, including the decorative shape portion 132 and the prongs 134, may be formed of any of a variety of materials, such as metals or plastics, for example,

The vase 140 of the example vase arrangement 100 of FIG. 1 has a vase body 142 formed with a bottom (not visible in FIG. 1) and at least one wall 144. In the example of FIG. 1, the vase 140 is provided with a circular cross section and, therefore, has a circular or conical wall around the perimeter. An opening 146 in the top of the vase allows access to the inside of the vase. In various examples, the vase may be formed of any of a variety of materials including, but not limited to, glass, plastic or ceramic, for example.

Referring now to FIGS. 2-4, an example method for assembling the example vase arrangement 100 of FIG. 1 is illustrated. Referring first to FIG. 2, the vase insert 120 is positioned within the body of the vase 140. As noted above, the vase insert 120 is sized to fit within the vase and, in the illustrated examples, conforms substantially to the inside of the vase 140.

With the vase insert 120 within the vase 140, the receptacles 126 extend longitudinally into the vase 140. In this regard, the receptacles 126 are positioned to receive the prongs 134 of the decorative frame 130. When the prongs 134 are inserted into the hollow, straw-like shaft 128 of the receptacles 126, the decorative frame 130 is connected to the vase insert, as illustrated in FIG. 3. As noted above, the prongs 134 are coupled to the decorative shape portion 132 of the decorative frame 130. Thus, when flowers are inserted into the vase body, the flowers are accented by the decorative shape portion 132 of the decorative frame, as illustrated in the example of FIG. 4.

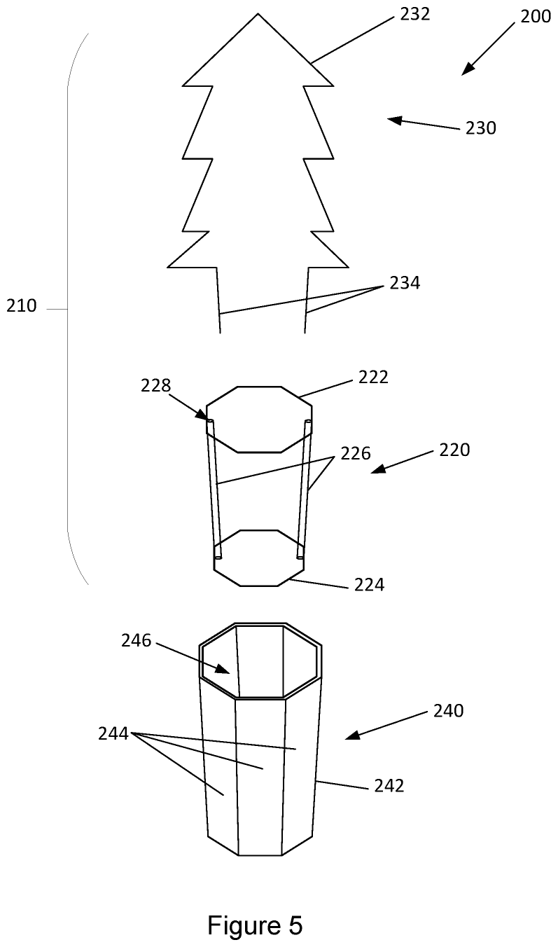

Referring now to FIG. 5, a perspective view of another example vase arrangement is illustrated. The example vase arrangement 200 of FIG. 5 is similar to the example vase arrangement 100 described above with reference to FIGS. 1-4 and includes a decorative assembly 210, including a vase insert 220 and a decorative frame 230, for assembly with a vase 240. While FIGS. 1-4 illustrate a vase arrangement 100 with a vase 140 and a vase insert 120 having a circular cross section, other examples may include any of a variety of cross sections. In some examples, the vase body has a polygon cross section in which the receptacles include two receptacles formed on opposing walls of the polygon cross section. For example, in the example vase arrangement 200 of FIG. 5, the vase 240 has an octagonal cross section. Similarly, the vase insert 220 has an upper circumferential portion 222 and a lower circumferential portion 224 with octagonal forms that allow the vase insert 220 to substantially conform to the inside of the vase 240. Further, when the vase insert 220 is positioned within the vase 240, the receptacles 226 are positioned on the inside of opposing walls 244 of the vase 240.

Further, as noted above, the example vase arrangement 100 of FIG. 1 is provided with a heart-shaped decorative shape portion 132 in the decorative frame 130. In other examples, the decorative shape portion 132 may be formed in any of a variety of desired shapes. For example, in the example vase arrangement 200 of FIG. 5, the decorative frame 230 is provided with a decorative shape portion 232 formed in the shape of a Christmas tree. In other examples, the decorative shape portion 232 may be formed in the shape of a pumpkin or any other decorative shape. In one example, the decorative shape may form text to express a greeting.

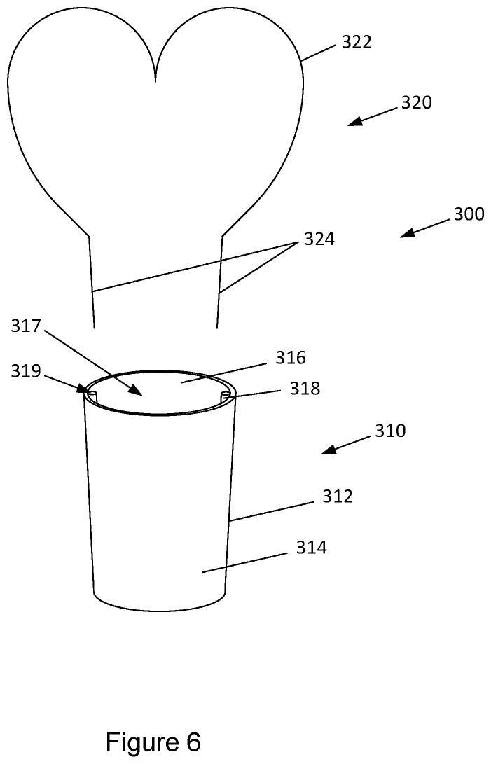

Referring now to FIG. 6, a perspective view of another example vase arrangement is illustrated. The example vase arrangement 300 of FIG. 3 includes a vase 310 and a decorative frame 320. The vase includes a vase body 312 having at least one wall 314. In the example of FIG. 6, the vase body 312 has a single circular wall 314. The vase body 312 forms an interior surface 316 formed by the inside of the wall 314 to define an interior cavity 317 to receive flowers therein, for example.

While the examples described above with reference to FIG. 1-5, a vase insert (e.g., vase insert 120, 220) is provided with receptacles (e.g., receptacles 126, 226), in the example vase arrangement 300 of FIG. 3, receptacles 318 are provided longitudinally on the interior surface 316 of the vase 310. The receptacles 318 may be integrally formed with the vase 310 or be adhered to the interior surface 316 with an adhesive or fasteners. Again, the receptacles 318 form a hollow, straw-like shaft 319 to receive prongs 324 of the decorative frame 320. The prongs 324 are coupled to a decorative shape portion 322.

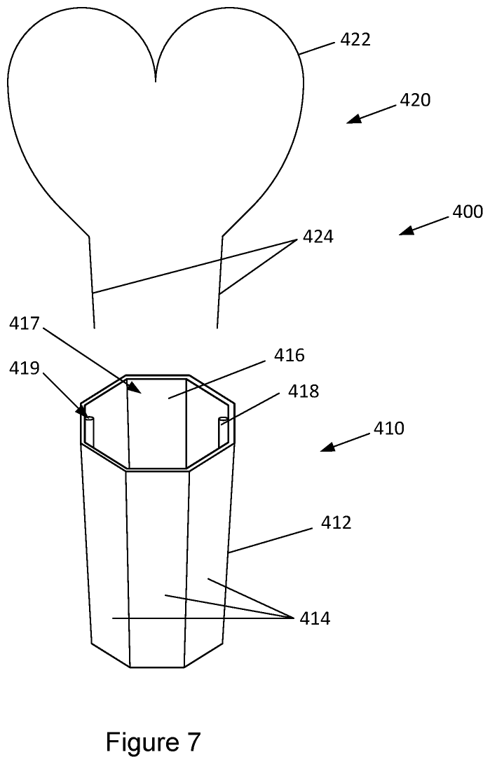

Referring now to FIG. 7, a perspective view of another example vase arrangement is illustrated. The example vase arrangement 400 of FIG. 7 is similar to the example vase arrangement 300 of FIG. 6 and includes a vase 410 and a decorative frame 420. Similar to the example of FIG. 6, the decorative frame 420 includes a decorative shape portion 422 coupled to prongs 424.

The vase 410 of the example vase arrangement of FIG. 7 includes a vase body 412 which has a polygon cross section. The vase 410 further includes receptacles 418 formed on the interior surface 416 of opposing walls 414 of the polygon cross section (octagon cross section in the example of FIG. 7).

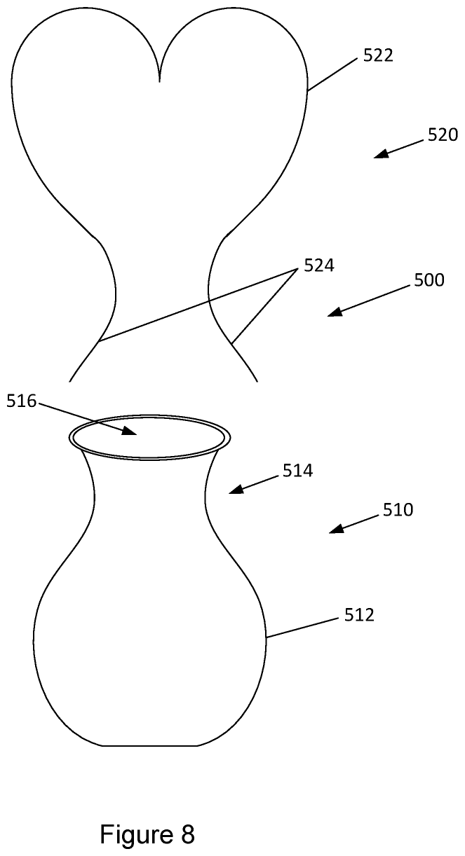

Referring now to FIG. 8, a perspective view of another example vase arrangement is illustrated. The example vase arrangement 500 of FIG. 8 includes a vase 510 and a decorative frame 520. In the example of FIG. 8, the vase 510 is formed with a vase body 512 with a neck 514. The interior surface 516 of the vase is narrowest at the neck 514 and expands both above and below the neck 514.

The decorative frame 520 includes a decorative shape portion 522 and prongs 524 coupled to the decorative shape portion 522. The prongs 524 in the example vase arrangement 500 of FIG. 8 are shaped to conform the neck 514 and the areas surrounding the neck 514.

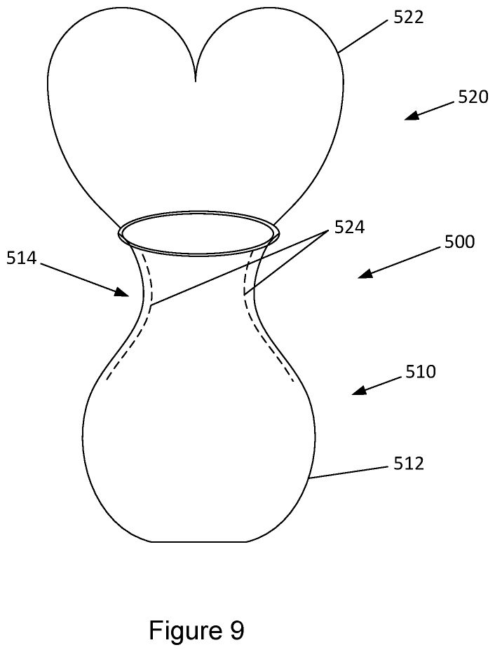

Referring now to FIG. 9, the example vase arrangement of FIG. 8 is illustrated in assembled form. In this assembled form, the prongs 524 of the decorative frame 520 are inserted into the vase. With the shape of the prongs 524 conforming to the interior surface of the neck 524 of the vase, the decorative frame 520 is securely positioned relative to the vase 510. In various examples, the insertion of the prongs 524 into the vase 510 may be achieved by squeezing the prongs 524 together to allow the prongs 524 to fit through the opening and the neck 514 of the vase 510.

Thus, the various examples described herein allow for a vase to frame flowers placed in the vase with a decorative shape. Various shapes may be provided, including a heart, Christmas tree or other decorative shapes.

The various examples set forth herein are described in terms of example block diagrams, flow charts and other illustrations. Those skilled in the art will appreciate that the illustrated examples and their various alternatives can be implemented without confinement to the illustrated examples. For example, block diagrams and their accompanying description should not be construed as mandating a particular architecture or configuration.

What is claimed is:

1. An apparatus, comprising:
a vase insert for insertion into a vase, the vase insert having receptacles extending into the vase; and
a decorative frame, the decorative frame having a decorative shape portion and prongs coupled to the decorative shape portion, the prongs for insertion into the receptacles of the vase insert.

2. The apparatus of claim 1, wherein the vase insert has a wire-frame body.

3. The apparatus of claim 2, wherein the wire frame body includes an upper circumferential portion and a lower circumferential portion connected by the receptacles.

4. The apparatus of claim 3, wherein the receptacles are formed of a hollow wire for receiving the prongs of the decorative frame therein.

5. The apparatus of claim 3, wherein the wire-frame body and the receptacles are formed of a metal.

6. The apparatus of claim 3, wherein the wire-frame body and the receptacles are formed of a plastic.

7. The apparatus of claim 1, wherein the decorative shape portion of the decorative frame is in the shape of at least one of a heart, a Christmas tree, a pumpkin, or text.

8. A vase assembly, comprising:
a vase body having longitudinal receptacles formed along at least one wall; and
a decorative frame, the decorative frame having a decorative shape portion and prongs coupled to the decorative shape portion, the prongs for insertion into the receptacles of the vase body.

9. The vase assembly of claim 8, wherein the vase body has a circular cross section and the receptacles include two receptacles formed on opposing regions of the circular cross section.

10. The vase assembly of claim 8, wherein the vase body has a polygon cross-section and the receptacles include two receptacles formed on opposing walls of the polygon cross-section.

11. The vase assembly of claim 8, wherein the vase body is formed of glass, plastic or ceramic.

12. The vase assembly of claim 8, wherein the receptacles are integrally formed with the vase body.

13. The vase assembly of claim 8, wherein the decorative shape portion of the decorative frame is in the shape of at least one of a heart, a Christmas tree, a pumpkin, or text.

14. A method, comprising:
positioning a vase insert within a vase body, the vase insert having longitudinal receptacles;
connecting a decorative frame to the vase insert, the decorative frame having a decorative shape portion and prongs coupled to the decorative shape portion, wherein the connecting includes insertion of the prongs into the receptacles of the vase insert.

15. The method of claim 14, further comprising:
inserting flowers into the vase body, wherein the flowers are accented by the decorative shape portion of the decorative frame.

16. The method of claim 14, wherein the vase insert has a wire-frame body.

17. The method of claim 16, wherein the wire frame body includes an upper circumferential portion and a lower circumferential portion connected by the receptacles.

18. The method of claim 17, wherein the receptacles are formed of a hollow wire for receiving the prongs of the decorative frame therein.

19. The method of claim 17, wherein the wire-frame body and the receptacles are formed of a metal or a plastic.

20. The method of claim 14, wherein the decorative shape portion of the decorative frame is in the shape of at least one of a heart, a Christmas tree, a pumpkin, or text.
